(19) United States
(12) Patent Application Publication
(10) Pub. No.: US 2007/0144166 A1
(43) Pub. Date: Jun. 28, 2007

(54) Hydrostatic drive system, with division of the quantity of hydraulic fluid at the pump, for two hydraulic circuits

(75) Inventors: Norbert Rueckgauer, Huettishein (DE); Heinz-Gerhard Essig, Lonsee (DE)

Correspondence Address: SCULLY, SCOTT, MURPHY & PRESSER, P.C., 400 GARDEN CITY PLAZA, SUITE 300, GARDEN CITY, NY, 11530, US

(73) Assignee: BRUENINGHAUS HYDROMATIK GMBH, ELCHINGEN GERMANY (DE)

(21) Appl. No.: 10/584,181

(22) PCT Filed: Nov. 24, 2004
(86) PCT No.: PCT/EP04/13345

§ 371 Date: Jun. 23, 2006

(30) Foreign Application Priority Data
Dec. 23, 2003 (DE) 103-60-959.8

(51) Int. Cl. F16D 31/02

(52) U.S. Cl. 60/485

(57) ABSTRACT

A hydrostatic drive system comprising at least one hydropump (100) and at least two hydromotors (104,109). The hydropump (100) divides its total hydraulic fluid flow into at least two partial hydraulic fluid flows which are respectively pumped in the form of a partial pump train (101,102) in a common cylinder drum (23) of the hydropump (100). The first connection (103) of a first hydromotor (104), which drives a first drive train (105), is connected to the first connection (38) of the first partial pump train (101) of the hydropump (100) and the second connection (107) thereof is connected to the second connection (38″) of the first pump train (101) of the hydropump (100). The first connection (108) of a second hydromotor (109) which drives a second drive train (111) is connected to the first connection (56) of the second partial pump train (102) of the hydropump (100) and the second connection (113) thereof is connected to the second connection (56) of the second partial pump strain (102) of the hydropump (100).

The invention relates to a hydrostatic drive system, with division of the quantity of hydraulic fluid at the pump, for two hydraulic circuits.

Hydraulic travelling drives which are designed for a cornering operation have, as is represented in EP 0 378 742 A2, two hydraulic circuits which are separate from one another, each hydraulic circuit consisting of a hydraulic pump and a hydraulic motor. In this way, it is possible to deliver separately, by two hydraulic pumps, the different quantities of hydraulic fluid for the two hydraulic motors in the case of cornering by the hydraulic travelling drive.

A hydraulic travelling drive according to EP 0 378 742 A2 is characterised by the difficulty of generating, by means of the two hydraulic pumps, the quantities of hydraulic fluid of equal magnitude, which are necessary in the case of straight-ahead travel, for the two hydraulic motors. Added to this is the fact that, in the case of straight-ahead travel by the hydraulic travelling drive, in the event of one drive line slipping or even spinning, the quantity of hydraulic fluid in the appertaining hydraulic circuit increases markedly, so that the hydraulic motor of the other drive line in each case, which is not slipping or spinning, is “bridged” hydraulically. In this way, the hydraulic travelling drive becomes inoperative.

What is disadvantageous about the hydrostatic travelling drive in EP 0 378 742 A2, moreover, is the use of two separate hydraulic pumps for the two hydraulic circuits, and the long axial overall length that this gives rise to.

The underlying object of the invention is therefore to further develop a hydrostatic travelling drive in such a way that use is made, in order to avoid slipping or spinning of one drive line, of a pump unit which is designed so as to be of substantially simpler construction than a pump unit consisting of two separate pumps.

The object of the invention is achieved by means of a hydrostatic drive system having the features in claim 1.

The hydraulic circuit consists of two drive lines which are each driven by a hydraulic motor, which motors are, in turn, supplied with a quantity of hydraulic fluid by a hydraulic pump. For this purpose, the hydraulic pump has two partial delivery lines which each deliver a partial flow of hydraulic fluid in a common cylinder drum belonging to the hydraulic pump, according to the invention, of the hydrostatic drive system according to the invention. The two partial delivery lines of the hydraulic pump, according to the invention, of the hydrostatic drive system according to the invention, assume the function of the two hydraulic pumps of the hydrostatic travelling drive in EP 0 378 742 A2. Since the two partial delivery lines of the hydraulic pump according to the invention are, from the construction point of view, hydraulically coupled to the effect that their delivery flows of hydraulic fluid are in a specific, fixed ratio to one another, it is possible to suppress a rise in a delivery flow of hydraulic fluid which supplies the hydraulic motor of a slipping or spinning drive line, by means of the constant delivery flow of hydraulic fluid which supplies the other driveline, in each case, which is not slipping or spinning. In this way, possible slipping or spinning of one of the two hydraulic motors can be prevented.

By comparison with the hydrostatic travelling drive in EP 0 378 742 A2, there is a single-pump system. This is characterised by a smaller space for construction, in particular a smaller axial overall length, and reduced outlay on pipework. Compared to a two-pump system, the hydrostatic drive system according to the invention needs no distributor gear unit for coupling the individual pumps mechanically, a fact which once again reduces the space required for construction and makes outlay on wear-induced maintenance and inspection unnecessary.

Advantageous refinements of the invention are indicated in the dependent claims.

Equalising flows between the two working conduits may be realised via activated 2/2-way valves in the event of non-slipping of a drive line, in order to guarantee equalisation of the differential in the case of cornering, between the two working conduits which are connected, on the feeding-in and feeding-out sides in each case, to the two connections of the two partial delivery lines of the hydraulic pump. The said 2/2-way valves may also be integrated in the hydraulic pump on the feeding-in and feeding-out sides.

One form of embodiment of the invention is represented in the drawings and will be described in greater detail below.

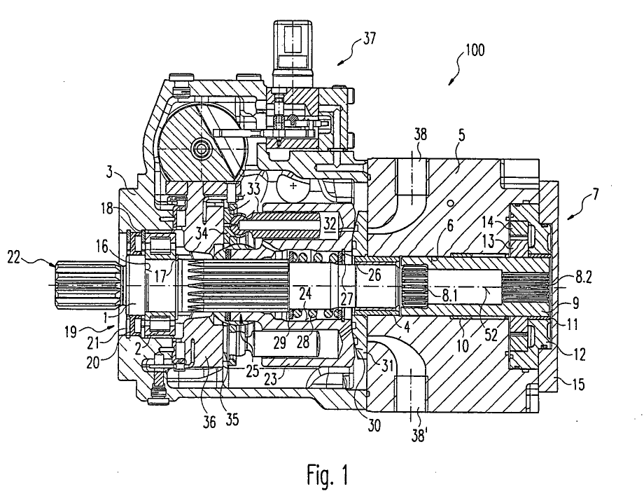

FIG. 1 shows a longitudinal section through a hydraulic pump belonging to a hydraulic drive system according to the invention with division of the quantity of hydraulic fluid at the pump;

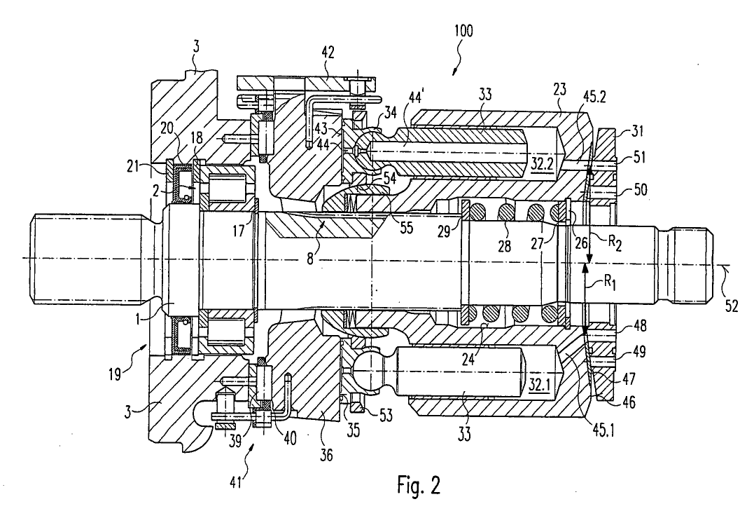

FIG. 2 shows an enlarged representation of a detail of the longitudinal section of the hydraulic pump of a hydraulic drive system according to the invention with division of the quantity of hydraulic fluid at the pump; and

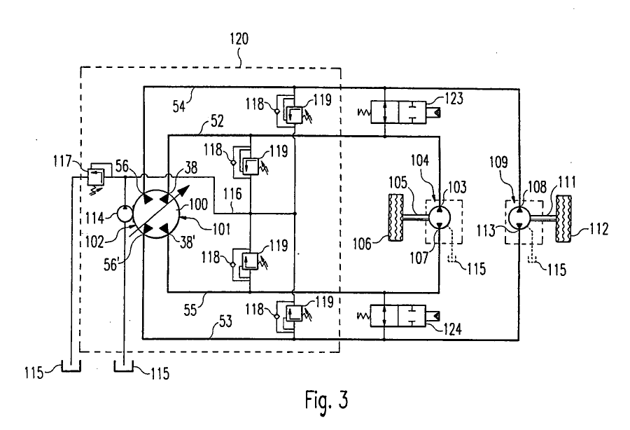

FIG. 3 shows a circuit diagram of one form of embodiment of a hydraulic drive system according to the invention with division of the quantity of hydraulic fluid at the pump.

One exemplified embodiment of the hydraulic pump 100 of the hydraulic drive system according to the invention with division of the quantity of hydraulic fluid at the pump will be described below with reference to FIGS. 1 and 2.

The longitudinal section represented in FIG. 1 through the hydraulic pump 100 shows how the common drive shaft 1 is mounted by means of a roller bearing 2 at one end of a pump housing 3. The common drive shaft 1 is additionally mounted in a plain bearing 4 which is disposed in a connecting plate 5 which closes the pump housing 3 at the opposite end.

Constructed in the connecting plate 5 is a clearance 6 which passes right through the connecting plate in the axial direction, in which the plain bearing 4 is disposed on the one hand, and through which the common drive shaft 1 passes on the other. On that side of the connecting plate 5 which faces away from the pump housing 3, the auxiliary pump 7 is inserted in a radial widened portion in the clearance 6. For the purpose of driving the auxiliary pump 7, the common drive shaft 1 has a tooth system 8.1 which is in engagement with the corresponding tooth system on an auxiliary pump shaft 9. The auxiliary pump shaft 9 is mounted in the clearance 6 by means of a first auxiliary pump plain bearing 10 and in the auxiliary pump connecting plate 12 by means of a second auxiliary pump plain bearing 11.

Disposed on the auxiliary pump shaft 9 is a gear wheel 13 which is in engagement with an internal geared wheel 14. The internal geared wheel 14, which is disposed in the auxiliary pump connecting plate 12 in a rotatable manner, is likewise driven, via the gear wheel 13, by the auxiliary pump shaft 9 and thereby ultimately by the common drive shaft 1. The suction-side and pressure-side connections for the auxiliary pump 7 are constructed in the auxiliary pump connecting plate 12. The auxiliary pump 7 is fixed in position in the radial widened portion of the clearance 6 in the connecting plate 5 by a cover 15 which is mounted on the connecting plate 5.

The inner race of the roller bearing 2 is fixed in position in the axial direction on the common drive shaft 1. The inner race rests, on one side, against a collar 16 on the common drive shaft 1 and, on the other side, is held in this axial position by a retaining ring 17 which is inserted in a groove in the common drive shaft 1. The axial position of the roller bearing 2 with respect to the pump housing 3 is determined by the retaining ring 18 which is inserted in a circumferential groove in the shaft aperture 19. A sealing ring 20 and, finally, another retaining ring 21 are also disposed in the shaft aperture 19 in the direction of the outer side of the pump housing 3, the retaining ring 21 being inserted in a circumferential groove in the shaft aperture 19.

A driving tooth system 22, via which the hydraulic pump is driven by a driving engine which is not represented, is constructed on that end of the common drive shaft 1 which protrudes from the pump housing 3.

Disposed in the interior of the pump housing 3 is a cylinder drum 23 which has a central through-aperture 24 through which the common drive shaft 1 passes. The cylinder drum 23 is connected, via another driving tooth system 25, to the common drive shaft 1 in a manner secured against torsion but displaceable in the axial direction, so that a rotating movement of the common drive shaft 1 is transmitted to the cylinder drum 23.

Another retaining ring 26, against which a first supporting washer 27 rests, is inserted in a groove constructed in the central through-aperture 24. The first supporting washer 27 forms a first spring bearing for a compression spring 28. A second spring bearing for the compression spring 28 is formed by a second supporting washer 29 which is supported against the end face of the additional driving tooth system 25. The compression spring 28 thereby exerts a force, in the opposite axial direction in each case, on the common drive shaft 1 on the one hand, and on the cylinder drum 23 on the other hand. The common drive shaft 1 is loaded in such a way that the outer race of the roller bearing 2 is supported against the retaining ring 18.

In the opposite direction, the compression spring 28 acts on the cylinder drum 23 which is held in abutment against a control plate 31 by a spherical depression 30 constructed on the end face of the cylinder drum 23. The control plate 31, in turn, rests against the connecting plate 5 in a sealing manner with the side that faces away from the cylinder drum 23. The cylinder drum 23 is centred by means of the spherical depression 30, which corresponds with a suitable spherical contour on the control plate 31.

The position of the control plate 31 in the radial direction is fixed by the outer periphery of the plain bearing 4. For this purpose, the plain bearing 4 is inserted only partially in the clearance 6 in the connecting plate 5.

Cylinder bores 32, in which pistons 33 which are longitudinally displaceable in said cylinder bores 32 are disposed, are incorporated in the cylinder drum 23 in a manner distributed over a common pitch circle. At the end that faces away from the spherical depression 30, the pistons 33 partially protrude from the cylinder drum 23. At this end, there is fastened to each of the pistons 33 a sliding shoe 34 via which the pistons 33 are supported on a running surface 35 on a swivelling disc 36.

In order to produce a movement of stroke of the pistons 33, the angle which the running surface 35 of the swivelling disc 36 forms with the central axis is variable. For this purpose, the swivelling disc 36 can be adjusted in its inclination by the adjusting arrangement 37. The swivelling disc 36 is mounted in the pump housing 3 in roller bearings in order to absorb the forces which are transmitted to the swivelling disc 36 by the sliding shoes 34.

A first connection 38, a second connection 38′, a third connection 56 and a fourth connection 56′ are provided in the connecting plate 5 for the purpose of connecting the hydraulic pump 100 to a first hydraulic circuit and to a second hydraulic circuit. Represented diagrammatically in FIG. 1 are a first connection 38 and a second connection 38′ which can be connected via the control plate 31, in a manner which is not shown, to the cylinder bores 32 and form a first partial delivery line 101 of the hydraulic pump 100 for a first hydraulic circuit. The third and fourth connections 56 and 56′, which are not represented in FIG. 1, can be connected to the cylinder bores 32 in an analogous manner, and form the second partial delivery line 102 of the hydraulic pump 100 for a second hydraulic circuit.

An enlarged representation of the components which interact in the interior of the pump housing 3 is represented in FIG. 2.

On its side that faces away from the running surface 35, the swivelling disc 36 is supported on a cylinder-roller bearing 39, the cylinder rollers of which are held by a bearing cage 40. In order to ensure a reliable return of the cylinder rollers into their original location after each swivelling movement, the bearing cage 40 is fastened to a retaining mechanism 41, by means of which the bearing cage 40 performs a controlled movement both when swivelling out and also when swivelling back.

For the purpose of performing a swivelling movement, the swivelling disc 36 is coupled to a sliding block 42 which rotates the swivelling disc 36, in a manner which is not represented, about an axis which lies in the plane of the drawing.

The cylinder bores, which are designated generally by 32 in FIG. 1, are subdivided into a first group of cylinder bores 32.1 and a second group of cylinder bores 32.2. As has already been explained briefly in the remarks on the subject of FIG. 1, a sliding shoe 34 is disposed on each of the pistons 33 at the end that faces away from the control plate 31. The sliding shoe 34 is fastened, by means of a clearance, to a spherical head of the piston 33, so that the sliding shoe 34 is fixed in position on the piston 33 in a movable manner, and pulling and pressing forces can be transmitted.

A sliding surface 43, by which the sliding shoe 34, and thereby the piston 33, is supported on the running surface 35 of the swivelling disc 36, is constructed on the sliding shoe 34. Constructed in the sliding surface 43 are lubricating-oil grooves which are connected to the cylinder bores 32 constructed in the cylinder drum 23 via a lubricating-oil duct 44 which is constructed in the sliding shoe 34 and is continued in the form of a lubricating-oil bore 44′ in the piston 33.

Because the sliding shoes 34 are supported against the running surface 35, the pistons 33 perform a movement of stroke when the common drive shaft 1 rotates, as a result of which movement the pressure medium located in the cylinder spaces in the cylinder drum 23 is pressurised. Some of this pressure medium passes out at the sliding surface 43 and thus forms a hydrodynamic bearing for the sliding shoe 34 on the running surface 35.

In order to convey the pressure medium from the cylinder spaces into a first or second hydraulic circuit, first connecting ducts 45.1 and second connecting ducts 45.2 are connected, in each case, to the cylinder bores of the first group 32.1 and the cylinder bores of the second group 32.2 respectively. The first and second connecting ducts 45.1 and 45.2 extend from the cylinder bores of the first group 32.1 and the cylinder bores of the second group 32.2 respectively, to the spherical depression 30 which is constructed on one end face 46 of the cylinder drum 23.

A first control pocket 48 and a second control pocket 49, which pass through the control plate 31 in the axial direction, are constructed in the control plate 31 which is connected to the connecting plate 5 in a manner secured against torsion.

A third control pocket 50 and a fourth control pocket 51 are also preferably constructed in the control plate 31. While the first and third control pockets 48 and 50 are connected, via the connecting plate 5, to working conduits 52 and 53, respectively, of the first hydraulic circuit, the second control pocket 49 and the fourth control pocket 51 are connected, in a corresponding manner, to the working conduits 54 and 55, respectively, of the second hydraulic circuit.

The first and third control pockets 48 and 50 are at an identical first distance R₁′ from the longitudinal axis 52 of the cylinder drum 23 which is smaller than the second distance R₂′ from the longitudinal axis 52, which distance is again identical for the second control pocket 49 and the fourth control pocket 51. In the course of one revolution of the common drive shaft 1, the first connecting ducts 45.1 are connected in turn to the first control pocket 48 and the third control pocket 50, so that, because of the movement of stroke of the pistons 33 disposed in the cylinder bores 32.1 of the first group, the pressure medium is sucked in, for example via the third control pocket 50, and pumped into that working conduit 52 or 53 of the first hydraulic circuit which is on the pressure side, via the first control pocket 48. For this purpose, the first connecting ducts 45.1 open onto the end face 46 of the cylinder drum 23 at a first distance R₁ from the longitudinal axis 52 of the cylinder drum 23 which corresponds to the first distance R₁′ of the first and third control pockets, 48 and 50 respectively, from the longitudinal axis 52 of the cylinder drum 23.

In the exemplified embodiment represented, the first connecting ducts 45.1 are disposed in the cylinder drum 23 in such a way that they have a radial component of direction as a result of which the first distance R₁ of the outlet on the end face 46 is smaller than the distance on the opposite side of the first connecting ducts 45.1. The second connecting ducts 45.2 accordingly open onto the end face 46 of the cylinder drum 23 at a second distance R₂ which corresponds with a second distance R₂′ of the second and fourth control pockets 49 and 51 from the longitudinal axis 52. In the course of one revolution of the common drive shaft 1, the cylinder bores of the second group 32.2 are thereby alternately connected to the second and fourth control pockets 49 and 51 via the second connecting ducts 32.2.

In order to prevent the sliding shoes 34 from lifting off the running surface 35 of the swivelling disc 36 during a suction stroke, a holding-down plate 53 is provided, which engages round the sliding shoes 34 at an offset which is provided for that purpose. The holding-down plate 53 has a spherical central clearance 54 with which it is supported against a supporting head 55 which is disposed on that end of the cylinder drum 23 which faces away from the end face 46.

FIG. 3 shows one form of embodiment of a hydraulic drive system according to the invention with division of the quantity of hydraulic fluid at the pump, which form of embodiment uses the hydraulic pump 100 according to the invention which has been described above, with two partial delivery lines 101 and 102.

The first connection 38 of the first partial delivery line 101 of the hydraulic pump 100 is connected to the first connection 103 of the first hydraulic motor 104 via the first working conduits 52. The first hydraulic motor 104 drives a first wheel 106 of a vehicle via a first drive line 105. The second connection 107 of the first hydraulic motor 104 is connected, via the working conduit 55, to the second connection 38′ of the first partial delivery line 101 of the hydraulic pump 100. The first connection 56 of the second partial delivery line 102 of the hydraulic pump 100 is connected to the first connection 108 of the second hydraulic motor 109 via the working conduit 54. The second hydraulic motor 109 drives a second wheel 112 of a vehicle via a second drive line 111. The second connection 113 of the second hydraulic motor is connected, via the working conduit 53, to the second connection 56′ of the second partial delivery line 102 of the hydraulic pump 100 according to the invention. The leakage volume of the first and second hydraulic motors 104 and 109 is connected, in each case, to a hydraulic tank 115 for the purpose of discharging leaking hydraulic fluid.

The hydraulic pump 100, which is adjustable in the quantity of its hydraulic fluid, is mechanically coupled, with its two partial delivery lines 101 and 102, to an auxiliary pump 114 via a drive shaft which is not represented in FIG. 3. The auxiliary pump 114 delivers a hydraulic fluid into a feeding conduit 116 from a tank 115. The pressure of the hydraulic fluid in the feeding conduit 116 is set to a specific level via a pressure-limiting valve 117. If there is a drop in pressure in the working conduits 52, 53, 54 and/or 55, hydraulic fluid is fed into the working conduit 52, 53, 54 and/or 55 afterwards from the feeding conduit 116 via a non-return valve 118 in each case. If an excess pressure occurs in the working conduits 52, 53, 54 and/or 55, the excess pressure is discharged into the feeding conduit 116 in known manner via an excess-pressure valve 119 in each case from the working conduit 52, 53, 54 and/or 55 which is carrying an excess pressure. The hydraulic pump 100 with its two partial delivery lines 101 and 102, the auxiliary pump 114, the pressure-limiting valve 117 and also the four non-return valves 118 and the four excess-pressure valves 119 together form a pump unit 120.

The two partial delivery lines 101 and 102 of the adjustable hydraulic pump 100 form a separate hydraulic circuit in each case via the working conduits 52 and 55 and the first hydraulic motor 104, and via the working conduits 53 and 54 and the second hydraulic motor 109, respectively. However, these two hydraulic circuits are coupled to one another with respect to their respective delivery quantities of hydraulic fluid, since the two delivery quantities of hydraulic fluid are in a specific, fixed ratio to one another. This fixed ratio of the delivery quantities of hydraulic fluid of the two hydraulic circuits is realised as a result of the constructional design of the first and second delivery lines 101 and 102 in the adjustable hydraulic pump 100, as represented above.

Thus, if slipping or spinning of the wheel 106 or 112 occurs in the case of lack of adhesion of the wheel 106 or 112 on the surface of the carriageway, an accompanying rise in the flow of hydraulic fluid in the first hydraulic motor 104 or second hydraulic motor 109, is eliminated. Because the two delivery quantities of hydraulic fluid in the first and second delivery lines 101 and 102 of the hydraulic pump 100 are coupled, a rise in the delivery quantity of hydraulic fluid in the first or second delivery line 101 or 102 because of slipping or spinning of the wheel 106 or 112 is prevented by the delivery quantity of hydraulic fluid in the other delivery line 102 or 101, in each case, which delivery quantity continues to be constant. The delivery quantity of hydraulic fluid in the first or second delivery line 101 or 102 of the adjustable hydraulic pump 100, which delivery line is connected hydraulically to the hydraulic drive line 105 or 111 which is not slipping and not spinning, “brakes” the rising delivery flow of hydraulic fluid in the first or second delivery line 101 or 102 of the hydraulic circuit connected to the slipping or spinning hydraulic drive line 111 or 105.

Because of the different paths of the wheels, cornering operations lead to asymmetrical pressure conditions at the first or second hydraulic motor 104 or 109. Pressure differences of this kind between the working conduits 52 and 54 or 53 and 55 when the vehicle is cornering may be bridged by the interpolation of a 2/2-way valve 123 and 124 in each case. If these 2/2-way valves are switched off by the control electronics of the vehicle in the case of cornering and when no slipping of a wheel 106 or 112 occurs, the particular 2/2-way valve is switched into the open condition, in which the particular working conduits 52 and 54 or 53 and 55 are hydraulically connected to one another. In this way, hydraulic equalising flows take place between the working conduits 52 and 54 or 53 and 55 for the purpose of reducing the pressure difference between the working conduits 52 and 54 or 53 and 55.

The invention is not limited to the form of embodiment represented, and can also be used for driving tracked vehicles or for driving more than two wheels.

1. Hydrostatic drive system having at least one hydraulic pump and at least two hydraulic motors, wherein the hydraulic pump divides up its overall flow of hydraulic fluid over at least two partial flows of hydraulic fluid which are each delivered in a partial delivery line in a common cylinder drum belonging to the hydraulic pump, and wherein at least one first hydraulic motor driving a first drive line is connected by its first connection to the first connection of the first partial delivery line of the hydraulic pump, and by its second connection to the second connection of the first delivery line of the hydraulic pump, and at least one second hydraulic motor driving a second drive line is connected by its first connection to the first connection of the second partial delivery line of the hydraulic pump, and by its second connection to the second connection of the second partial delivery line of the hydraulic pump.

2. Hydrostatic drive system according to claim 1, wherein if necessary, an equalizing flow for equalizing a differential takes place, in each case, between the two partial flows of hydraulic fluid in the two particular working conduits which are connected, in each case, to the two first or second connections of the hydraulic pump.

3. Hydrostatic drive system according to claim 2, wherein the equalizing flow between the two partial flows of hydraulic fluid is realised, in each case, via a 2/2-way valve which is connected between the two working conduits and which is closed if necessary.

4. Hydrostatic drive system according to claim 3, wherein one of the two 2/2-way valves is integrated into the hydraulic pump on the feeding-in and feeding-out sides in each case.

5. Hydrostatic drive system according to claim 1, wherein the hydraulic pump is designed as an adjusting pump.

6. Hydrostatic drive system according to claim 1, wherein each hydraulic motor is designed as a fixed-displacement motor, a torque motor and/or an adjusting motor.
